(19) United States
(12) Patent Application Publication
(10) Pub. No.: US 2005/0268431 A1
(43) Pub. Date: Dec. 8, 2005

(54) Support and angle adjustable device for monitors

(76) Inventor: Huan-Chen Lo, Yang Mei Town (TW)

Correspondence Address: SUPREME PATENT SERVICES, POST OFFICE BOX 2339, SARATOGA, CA, 95070, US

(21) Appl. No.: 10/850,522

(22) Filed: May 19, 2004

(51) Int. Cl. E05D 7/06

(52) U.S. Cl. 16/239

(57) ABSTRACT

A support and angle adjustable device includes a U-shaped support member having two opposite walls and one of the two opposite walls has a hexagonal hole and the other one of the two opposite walls has a through hole. A pin with a hexagonal body extends through the through hole and is engaged with the hexagonal hole. The body includes a threaded end that has two surfaces defined in an outer surface thereof and extends through an adjusting hole defined through an L-shaped connection plate that is connected to a liquid crystal display. The hexagonal body is strong enough to support the monitor and the U-shaped support member is light in weight and has satisfied structural strength. The threaded end rotates an angle in the adjusting hole of the connection plate when adjusting the monitor.

### FIELD OF THE INVENTION

The present invention relates to a support and angle adjustable device for monitors and is strong in structure at lower manufacturing cost and easily to be installed.

### BACKGROUND OF THE INVENTION

A conventional support and angle adjustable device for a display, such as a computer monitor, for example a liquid crystal display (LCD), is illustrated in FIG. 9 and includes support piece 70 with two lugs and two connection plates 40′ are respectively connected to the two lugs by two respective adjusting devices 30′. The adjusting device 30′ includes a pin and several washers 74 and the monitor is connected to the connection plates 40′ and can be pivoted about the two pins. It is noted that the two pins cannot support the weight of the monitor and may tilt after a long term of use. Besides, it is not easy to install to or remove from the device and has a problem of occupying too much space when being packed.

Therefore, it is desired to have a support and angle adjustable device for monitors wherein the device is strong enough to support the monitor and light in weight. The device is easily to assemble and remove from the monitor.

### SUMMARY OF THE INVENTION

In accordance with an aspect of the present invention, there is provided a support and angle adjustable device for monitors and the device comprises an L-shaped connection plate that includes a first section to be connected to a monitor and a second section which has an adjusting hole. A U-shaped support member has a hexagonal hole in one of two opposite walls and a through hole is defined through the other one of the two opposite walls. An adjusting unit includes a pin that has a body with hexagonal cross section. The pin extends through the two opposite walls of the support member and a first threaded end of the pin extends through the through hole and the body is engaged with the hexagonal hole. A second threaded end of the pin extends through the adjusting hole of the connection plate. Two surfaces are defined in opposite with each other in the second threaded end the adjusting hole is shaped to allow the second threaded end to be rotated an angle.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 shows a support and angle adjustable device including an insertion of the present invention;

FIG. 2 shows the support and angle adjustable device connected to an insertion that is received in a support frame;

FIG. 3 is an exploded view of the support and angle adjustable device, the insertion, and the support frame to receive the insertion;

FIG. 4 shows a threaded end of a pin extending through an adjusting hole of a connection plate;

FIG. 5 shows that the support and angle adjustable device of the present invention is connected to a wall support member;

FIGS. 6 and 7 show the threaded end of the pin is rotated an angle in the adjusting hole of the connection plate;

FIG. 8 shows a perspective view of the pin of the support and angle adjustable device of the present invention, and

FIG. 9 is an exploded view showing a conventional support and angle adjustable device for monitors.

### DETAILED DESCRIPTION OF THE PREFERRED EMBODIMENT

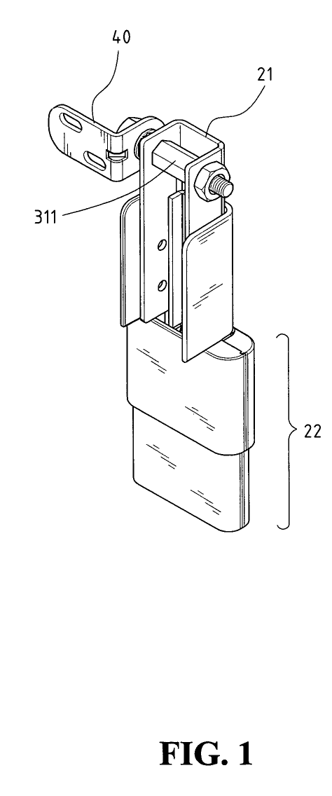

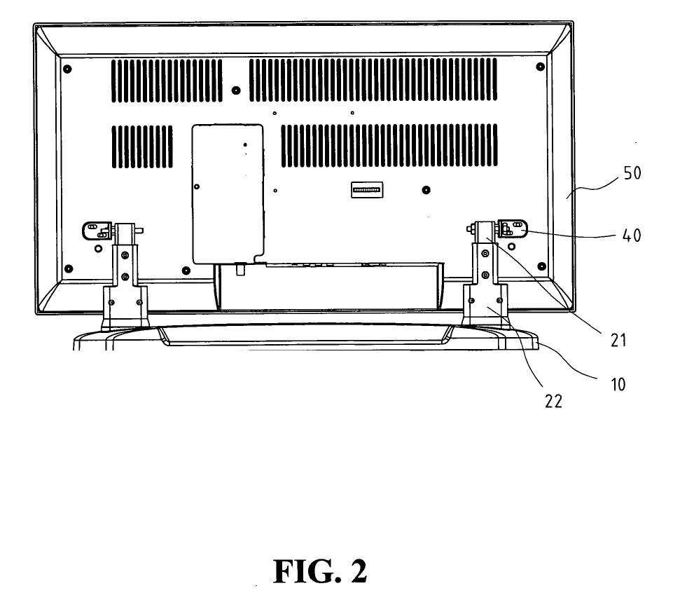

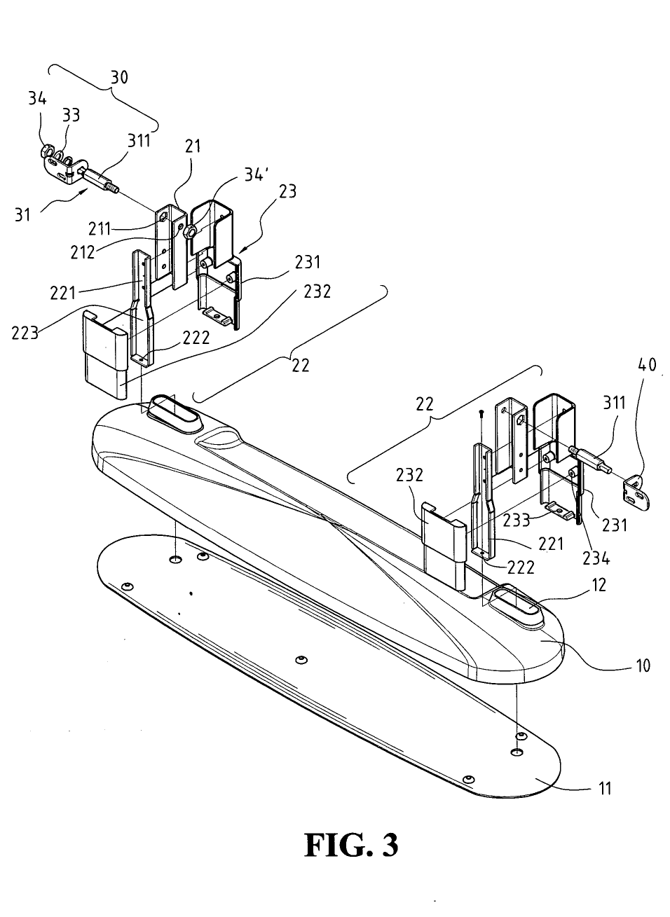

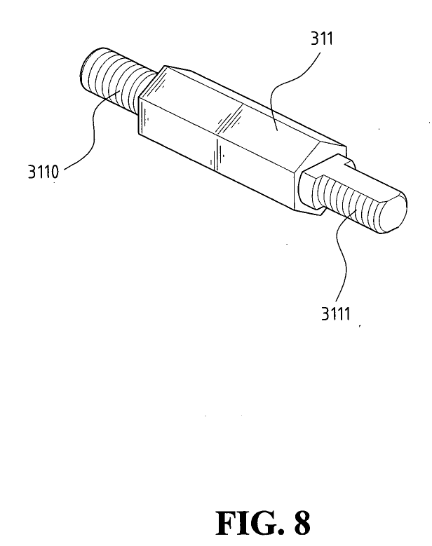

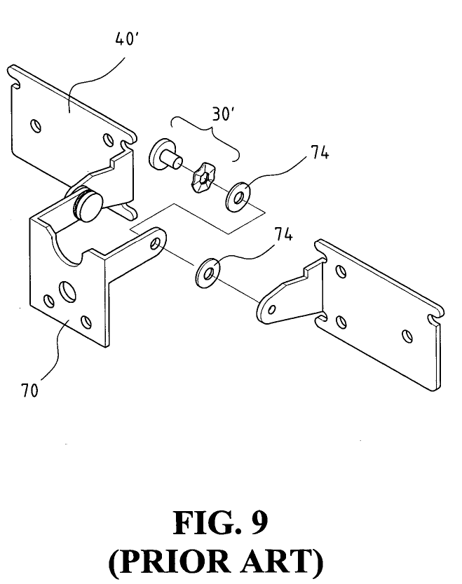

Referring to the drawings and in particular FIGS. 1-3 and 8, a support and angle adjustable device for a computer monitor, such as a liquid crystal display, comprises an L-shaped connection plate 40 having a first section connectable to a monitor 50 as shown in FIG. 2 and a second section defining therethrough an adjusting hole 41.

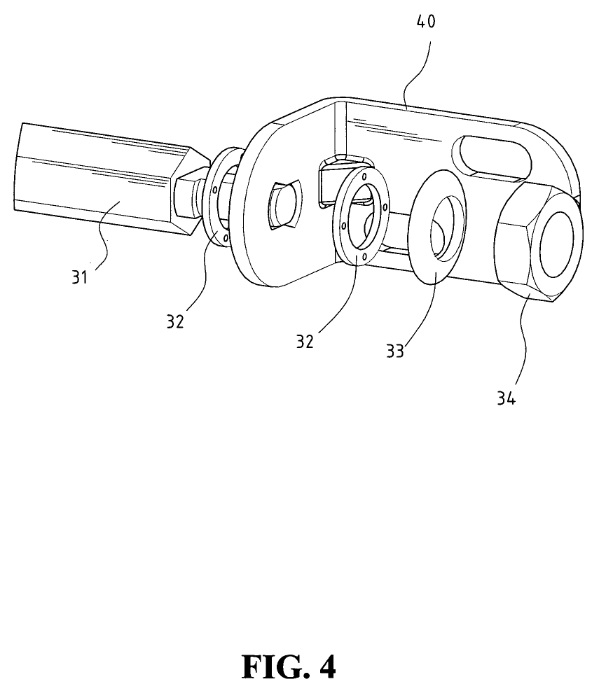

A U-shaped support member 21 includes two opposite walls of which one defines a hexagonal hole 211 and the other one forms a through hole 212. An adjusting unit 30 includes a pin 31 that has a body 311 with a hexagonal cross section and first and second threaded sections 3110, 3111 respectively at opposite ends thereof. The pin 31 extends through the walls of the support member 21 with the first threaded end 3110 extending through the through hole 212 and coupled to a nut. The body 311 engages the hexagonal hole 211 and the second threaded end 3111 extends through the adjusting hole 41 in the second section of the connection plate 40. Further referring to FIG. 4, two washers 32 are mounted to the second threaded end 3111 to clamp the second section of the connection plate 40 therebetween. A flexible washer 33 and a nut 34 are mounted to the second threaded end of the body 311 in sequence. The second threaded end 3111 has two surfaces defined in opposite with each other.

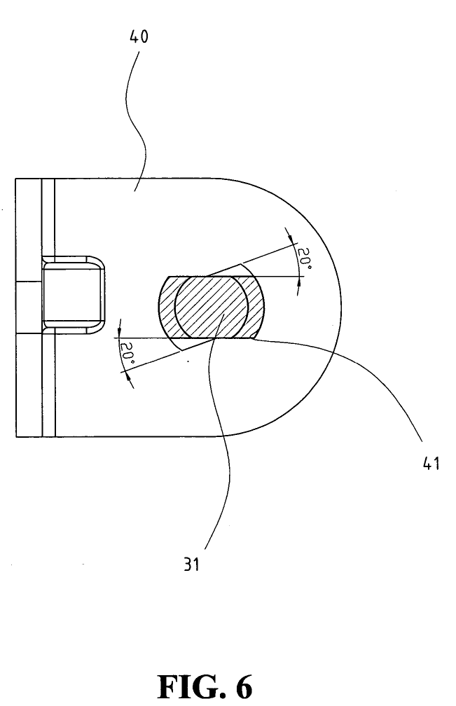

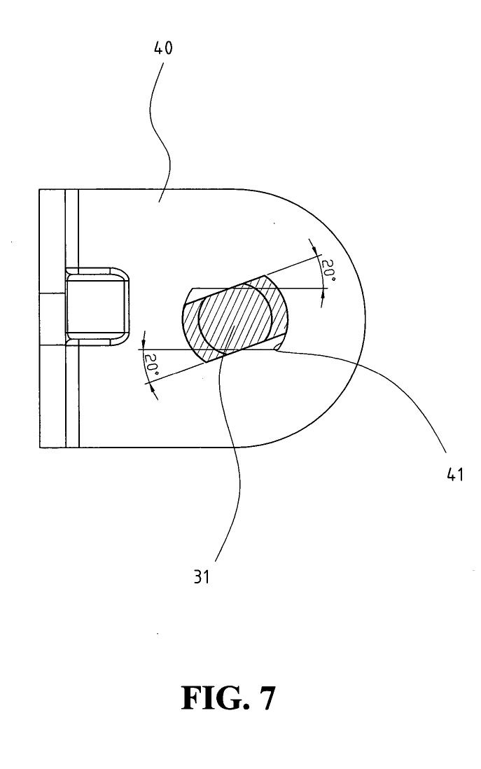

Referring to FIGS. 6 and 7, the adjusting hole 41 is shaped to allow the second threaded end 3111 to rotate an angle, such as 20 degrees. It is noted that the U-shaped support member 40 is light in weight and can be manufactured with low costs. The U-shaped support member 40 has a sufficient structural strength to bear the weight of the monitor 50. The hexagonal cross section of the body 311 of the pin 31 is stronger than a pin having a circular cross section and the engagement of the hexagonal body 311 and the hexagonal hole 211 ensures that the pin 31 does not co-rotate when adjusting the monitor 50.

An insertion 22 is connected to the support member 40 and includes a central part 221, a front cover 231, and a rear cover 232. The central part 221 is fixed to the support member 21 and includes a lower portion 223 that is sandwiched between the front cover 231 and the rear cover 232. The central part 221 includes a flange extending from a lower end thereof and a first positioning hole 222 is defined through the flange. The front cover 231 includes a tongue extending from a lower end thereof and a second positioning hole 233 is defined through the tongue. A screw extends through the first and second positioning holes 222, 233 to connect the front cover 231 and the central part 221. The front cover 231 further has two cylindrical receiving members 234 extending from an inside thereof and the rear cover 232 includes protrusions (not shown) which are inserted in the receiving members 234 so as to easily position the front and rear covers 231, 232. The combined front and rear covers 231, 232 are inserted in a hole 12 in a support frame 10 that is fixed on a base 11.

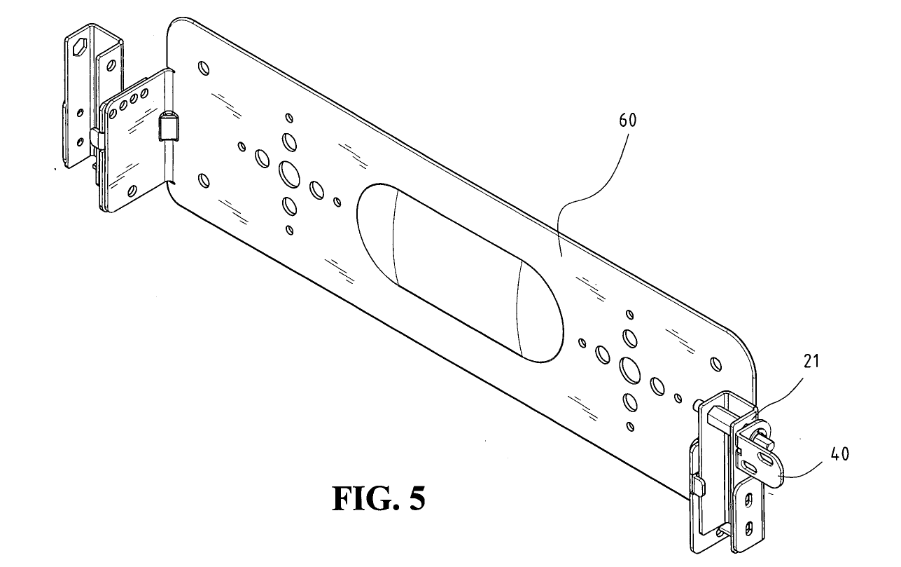

Referring to FIG. 5, when cooperated with a monitor that is hanged on a wall, a positioning plate 60 is required which is fixed on a wall and includes two side wings. The insertion 22 in the first embodiment as disclosed in FIG. 1 is omitted and the support member 21 is fixed to the side wing such that the monitor is hanged on the wall by the positioning plate 60.

The hexagonal body 311 of the pin 31 can bear a heavier load than a pin with a circular cross section does for such a circular cross section must have an increased diameter when subject to a heavy weight of a monitor. The pin with a circular cross section tends to rotate with the load in a circular hole and cannot hold the monitor in position. The support member 21 can also be a hollow tube with a rectangular cross section.

While we have shown and described the embodiment in accordance with the present invention, it should be clear to those skilled in the art that further embodiments may be made without departing from the scope of the present invention.

1. A support and angle adjustable device comprising:
an L-shaped connection plate comprising a first section adapted to connect to a monitor and a second section defining therethrough an adjusting hole;
a support member having two opposite walls of which one defines a hexagonal hole and the other one defines a through hole;
an adjusting unit comprising a pin that has a body with hexagonal cross section, the pin having a first threaded end and a second threaded end, the pin extending through the two opposite walls of the support member and the first threaded end extending through the through hole, the body engaging the hexagonal hole and the second threaded end extending through the adjusting hole in the second section of the connection plate, two surfaces defined in opposite with each other in the second threaded end, the adjusting hole being shaped to allow the second threaded end to be rotated an angle, and
an insertion comprising a central part, a front cover and a rear cover, the central part fixed to the support member and sandwiched between the front cover and the rear cover, the insertion being adapted to be inserted in a support frame.

2. The device as claimed in claim 1, wherein the support member is U-shaped.

3. The device as claimed in claim 1, wherein the central part includes a flange extending from a lower end thereof and a first positioning hole is defined through the flange, the front cover including a tongue extending from a lower end thereof and a second positioning hole defined through the tongue, a screw extending through the first and second positioning holes to connect the front cover and the central part.

4. A support and angle adjustable device comprising:
an L-shaped connection plate comprising a first section adapted to connect to a monitor and a second section defining therethrough an adjusting hole;
a support member having two opposite walls of which one defines a hexagonal hole and the other forms a through hole; and
an adjusting unit comprising a pin that has a body with hexagonal cross section, the pin having a first threaded end and a second threaded end, the pin extending through the two opposite walls of the support member and the first threaded end extending through the through hole, the body engaged with the hexagonal hole and the second threaded end extending through the adjusting hole in the second section of the connection plate, two surfaces defined in opposite with each other in the second threaded end, the adjusting hole being shaped to allow the second threaded end to be rotated an angle.

5. The device as claimed in claim 4, wherein the support member is U-shaped.
